(19) United States
(12) Patent Application Publication
(10) Pub. No.: US 2010/0295701 A1
(43) Pub. Date: Nov. 25, 2010

(54) Interconnection device for electronic circuits, notably microwave electronic circuits

(75) Inventors: Stéphane Denis, La Bouexiere (FR); Jean-Pierre Cazenave, Rennes (FR); Gérard Haquet, Chateaubourg (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/783,426

(22) Filed: May 19, 2010

(30) Foreign Application Priority Data
May 20, 2009 (FR) 09 02476

(51) Int. Cl. G01V 3/00

(52) U.S. Cl. 340/854.3

(57) ABSTRACT

Interconnection device for electronic circuits, notably microwave electronic circuits, characterized in that it comprises at least one transmission line coupled to an earth line, the two lines being made on a face of a dielectric substrate, at least one metallization surface forming on the other face of the dielectric substrate at least one coupling element disposed on a surface substantially equal in area to the surface occupied by the transmission line and the earth line, the interconnection being carried out substantially at the level of the ends of the transmission line and of the earth line.

The present invention relates to an interconnection device for electronic circuits, notably microwave electronic circuits. It applies notably to the electronic links between various electronic circuits.

The present invention relates to applications for which electrical links are required, between various electronic circuits. In what follows, the concept of electronic circuit has to be understood in its widest acceptation, that is to say an electronic circuit can take the form of an electronic module, for example of a chip, of an electro-mechanical micro-system, usually designated by the acronym “MEMS”, standing for the expression “Micro-Electro-Mechanical System”, of a packaged integrated circuit, of a module of simple or stacked printed cards, of a three-dimensional module, etc. These links can electrically inter-link physically homogeneous electronic circuits: for example chips, or else physically heterogeneous electronic circuits, when required for example to electrically link a chip to a support for interconnection with a substrate, a printed card, a package, etc. The signals considered can be of a fast digital or else microwave analogue nature.

More particularly, the present invention pertains to applications in which the aforementioned electrical links are intended for the transmission of electrical signals occupying a wide band of frequencies, and/or which are situated in high frequencies with regard to the dimensions of the links to be produced, and/or which exhibit high powers. It is for example considered that frequencies which are high with regard to the dimensions of the links to be produced, satisfy the inequality II>3.10⁹/1000.f, II representing the link length in metres, and f the frequency of the signal transmitted, in Hertz.

When this inequality is not met, it is all the more difficult to compensate for the link produced, the lower the characteristic impedance of the interfaces, the higher the required level of matching, and the wider the band of frequencies of interest.

With the aim of limiting the spurious influence of the linking elements, produced for example in the form of wires or strips, the electronic circuits which are to be electrically linked are placed as close together as possible. Consequently, the dimensions and the tolerances which are associated therewith and which are associated with the positioning of the elements, are reduced, to the detriment of production costs and manufacturing efficiencies.

This drawback is all the more critical the more complex the assemblies considered and because long chains of dimensions are involved. For example, in a relatively simple case where chips or power modules are mounted on heat sinks, through cavities made in a substrate, a chain of dimensions can be defined as the sum of the distance from the connection pad on the substrate with respect to the edge of the substrate, of the distance from the edge of the substrate to the edge of the chip or module, and of the distance from the edge of the chip or module, to the connection pad on the chip or module. A fine tolerance associated with such a chain of dimensions is achievable in practice, but at the price of necessarily expensive methods of manufacture and checking, and at the risk of low yield.

There exist solutions known from the prior art, implemented in order to limit the influence of the spurious phenomena or the mismatching of the connections.

A first known technique consists in using connection pins, whose shapes may be diverse. These connection pins can for example be through-pegs, stirrups, or else flat pins mounted at the surface of printed circuits. A drawback of this technique is that it is not effective for the transmission of signals at high frequency, and for the dissipation of large powers.

A second known technique consists in using micro-wiring comprising a plurality of conducting wires in parallel, usually two wires. Such a technique is, however, often limited by the surface area available on the connection pads, the surface area of which is limited by the frequency of the signals to be transmitted. It is also limited by the phenomenon of mutual inductance between the conducting wires.

A third known technique consists in using micro-wiring comprising microstrips. This technique, however, also exhibits the drawback of being limited by the surface area available on the connection pads, the surface area of which is limited by the frequency of the signals to be transmitted. Another drawback of this technique is that it is markedly more expensive to implement industrially, in comparison with the aforementioned second wire-based technique.

A fourth known technique consists in using conducting micro-balls soldered between metallized pads of modules mounted inverted with respect to one another. This technique is known by the name “inverted chip” technique, more usually termed “flip-chip”. For example, an electronic chip or a module equipped with an array of conducting balls—often designated by the initials BGA, from the expression “Ball Grid Array”—mounted inverted on a substrate. This technique is advantageous for links at very high frequency, and/or a very wide band of frequencies. However, this technique is expensive to implement industrially, and requires additional steps in the method of manufacture of the devices implementing them. Furthermore, this technique exhibits the drawback of not being effective in terms of thermal dissipation, when it is applied to monolithic electronic circuits, of chip type. It may turn out to be effective when it is applied to modules integrating a heat sink, but in such cases the technique turns out to be globally very expensive to implement industrially. This technique also exhibits the drawback of necessitating chips or modules designed specifically for assemblies of this type. Finally, it exhibits a drawback related to the difficulty, or indeed the impossibility, of carrying out visual checks on the links after assembly.

A fifth known technique consists in using connection micro-pads, assembled directly by soldering or by adhesive bonding onto electronic circuits mounted inverted with respect to one another. This technique is similar to the fourth known technique, described above, using micro-balls. For example, an electronic chip or a module equipped with an array of metallized connection micro-pads—often designated by the initials LGA, from the expression “Land Grid Array”—mounted inverted on a substrate. This technique also makes it possible to produce very high frequency and/or very wide band links. On the other hand, this technique is not effective for ensuring the matching of the differences in coefficients of expansion between the various electronic circuits. In a manner similar to the fourth technique described above, this technique exhibits the drawback of not being effective in terms of thermal dissipation, when it is applied to monolithic electronic circuits, of chip type. It may also turn out to be effective when it is applied to modules integrating a heat sink, but at the price of very expensive implementation. This technique also exhibits the drawback of necessitating chips or modules designed specifically for assemblies of this type. It also exhibits a drawback related to the difficulty, or indeed the impossibility, of carrying out visual checks of the links after assembly, even when certain links are made with pads which rise above the sides, for example for modules furnished with castellations, according to techniques specific to LGA.

A sixth known technique consists in using connection micro-tags intended for producing links by thermo-compression or by adhesive bonding. This technique allows the production of links with very high frequency and/or a very wide band of frequencies. However, this technique does not make it possible to ensure effective thermal dissipation. It also exhibits a drawback related to the difficulty, or indeed the impossibility, of carrying out visual checks of the links after assembly.

A seventh known technique consists of automatic adhesive bonding by tape, this technique is usually designated by the acronym “TAB” standing for the expression “Tape Automated Bonding”. This technique is based on an electrical circuit made on a fine and flexible substrate, whose tracks overshoot and are directly micro-wired onto the interconnection tags for interconnecting the elements to be linked, for example by thermo-compression or by collective soldering. This technique allows a collective linking mode, that is to say all the connection operations for one and the same printed circuit can be carried out simultaneously. The TAB technique allows for example the production of links with coplanar transmission lines, of earth/signal/earth type. Such lines exhibit the drawback of being sensitive to dissymmetries, of requiring a minimum of six contact points per link, of requiring earth planes of wide surface area, as well as great fineness in the production of the central line, in terms of track width and gap with the earth lines, with the aim of obtaining typical characteristic impedances of the order of 50Ω.

An aim of the present invention is to alleviate the drawbacks peculiar to the aforementioned known devices, by proposing an interconnection device for microwave electronic circuits that can be substituted for the known interconnection techniques, usually wire-based, or also for the coplanar transmission lines of earth/signal/earth type used for the production of links according to techniques of TAB type. An interconnection device according to the invention allows the transmission of electrical signals occupying a wide band of frequencies and/or situated at high frequencies with regard to the dimensions to be achieved and/or exhibiting high powers, with a high level of matching.

The present invention proposes that the electronic circuits be linked electrically with an element forming a transmission line of appropriate length and appropriate characteristic impedance. This approach is different from the known approaches of wire links which are rather more of a localized nature, whereas a transmission line is of a distributed nature. This transmission line exhibits a characteristic impedance and a mode of propagation that are very similar to those which are exhibited at the interfaces of the electronic circuits to be linked.

Because the interconnection device according to the various embodiments of the invention forms a transmission line, the performance—for example the insertion losses and matching losses—of the electrical link depend little on its length, up to the cutoff frequency of the link, which results from a spurious resonance. Such is not the case with known links using wires or strips.

An advantage of the invention is to allow the production of electrical links of transmission line type, whose dimensions make it possible to relax the elements of a chain of dimensions, and to distance the connection pads.

Another advantage of the invention is that it makes it possible to produce interconnection devices of smaller dimensions than links produced with coplanar lines of the earth/signal/earth type, whose assemblies are of reduced complexity, and whose immunity in relation to spurious phenomena is reduced.

Another advantage of the invention is that the type of electrical link that it proposes supports high electrical powers better than do wire links.

Yet another advantage of the invention is that the type of electrical link that it proposes confines the electromagnetic fields better than do wire links or links using strips of comparable size. This makes it possible to minimize the spurious couplings between electronic circuits disposed close together.

For this purpose, the subject of the invention is a device for interconnecting electronic circuits, characterized in that it comprises at least one transmission line coupled to an earth line, the two lines being made on a face of a dielectric substrate, at least one metallization surface forming on the other face of the dielectric substrate at least one coupling element for enhancing the electrical coupling between the two lines, the said coupling element being disposed on a surface substantially equal in area to the surface occupied by the transmission line and the earth line, the interconnection being carried out substantially at the level of the ends of the transmission line and of the earth line.

In one embodiment of the invention, connection pads are made at the ends of the transmission line and of the earth line.

In one embodiment of the invention, connection tags are made at the ends of the transmission line and of the earth line.

In one embodiment of the invention, the interconnection device can be characterized in that a plurality of coupling elements is formed by a plurality of metallization surfaces of identical shapes disposed in a substantially periodic manner at a determined distance from one another.

In one embodiment of the invention, the interconnection device can be characterized in that the transmission line and the earth line are substantially of the same dimensions and disposed in parallel.

In one embodiment of the invention, the interconnection device can be characterized in that the earth line is linked at the level of its central part, to a double line segment increasing the high cutoff frequency of the interconnection device.

In one embodiment of the invention, the interconnection device can be characterized in that the double line segment exhibits substantially a “T” shape whose vertical branch is linked at the level of the central part of the earth line, the horizontal branches extending parallel to the earth line over a length at least equal to the length of the earth line, the distal ends of the horizontal branches being prolonged by a surface extending perpendicularly to them.

In one embodiment of the invention, the interconnection device can be characterized in that a first transmission line is disposed parallel to the earth line disposed parallel to a second transmission line, the three lines forming a system of signal/earth/signal type.

In one embodiment of the invention, the interconnection device can be characterized in that the coupling elements are linked electrically to the earth line by conducting vias passing through the dielectric substrate.

In one embodiment of the invention, the interconnection device can be characterized in that a plurality of electrical links each formed by at least one transmission line and one earth line are made on the dielectric substrate.

In one embodiment of the invention, the interconnection device can be characterized in that the dielectric substrate is made of a flexible material.

In one embodiment of the invention, the interconnection device can be characterized in that the flexible material is a resin of polytetrafluoroethylene type filled with ceramic on woven glass fibre, or else an epoxy resin on woven glass, or any other organic flexible material.

In one embodiment of the invention, the interconnection device can be characterized in that the lines are made by a TAB-type tape-based automatic adhesive bonding technique.

Other characteristics and advantages of the invention will become apparent on reading the description given by way of example and with regard to the appended drawings which represent:

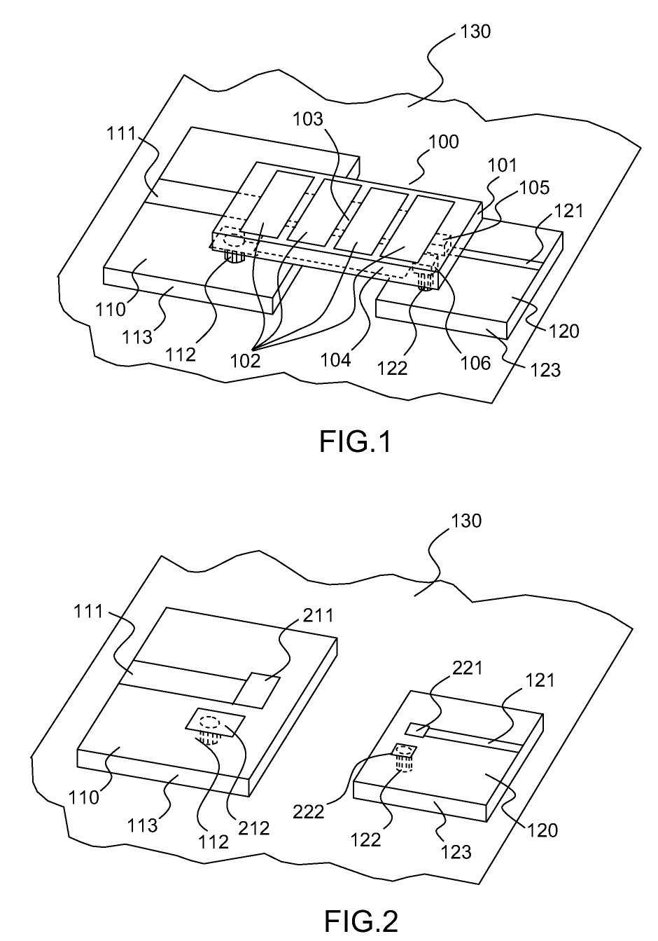

FIG. 1, a perspective view of an interconnection device according to an exemplary embodiment of the present invention, linking two electronic modules;

FIG. 2, a perspective view illustrating the detail of the two electronic modules linked electrically by an interconnection device according to an exemplary embodiment of the invention;

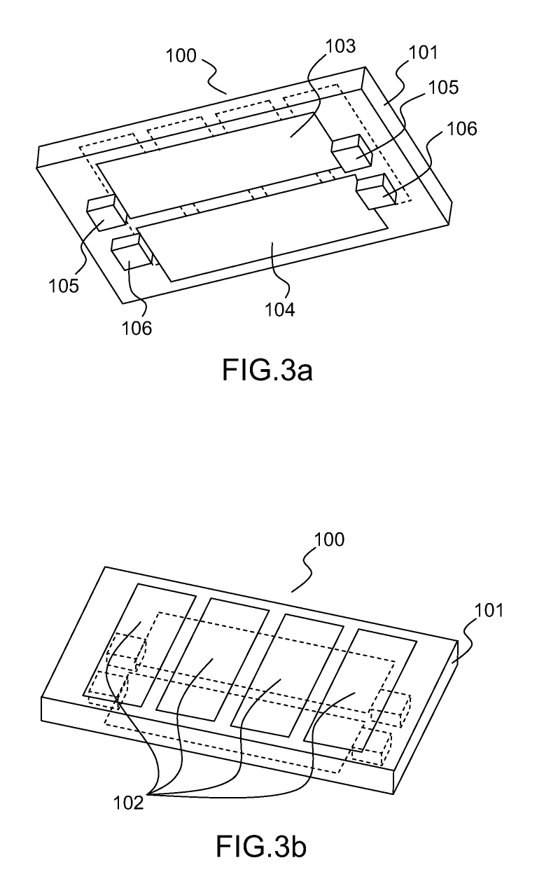

FIGS. 3a and 3b, perspective views illustrating the detail respectively of the underside and of the topside of an interconnection device according to an exemplary embodiment of the present invention;

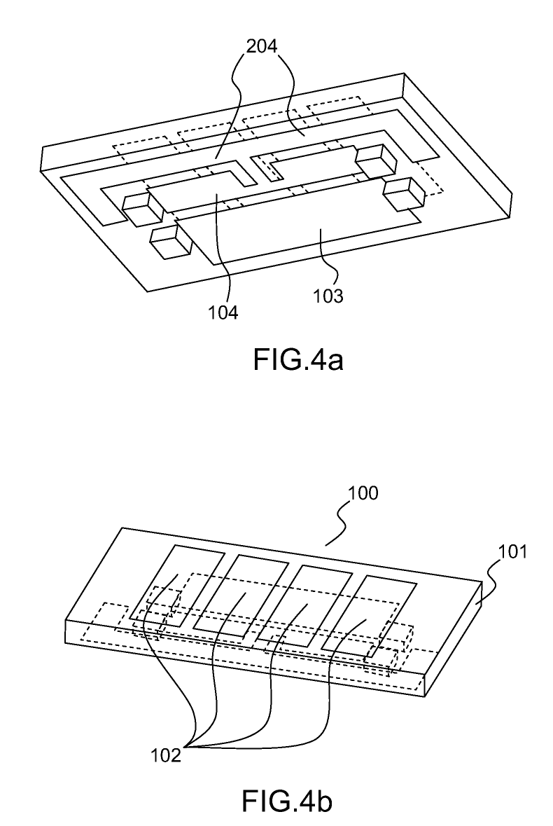

FIGS. 4a and 4b, perspective views illustrating the detail respectively of the underside and of the topside of an interconnection device according to an alternative exemplary embodiment of the present invention;

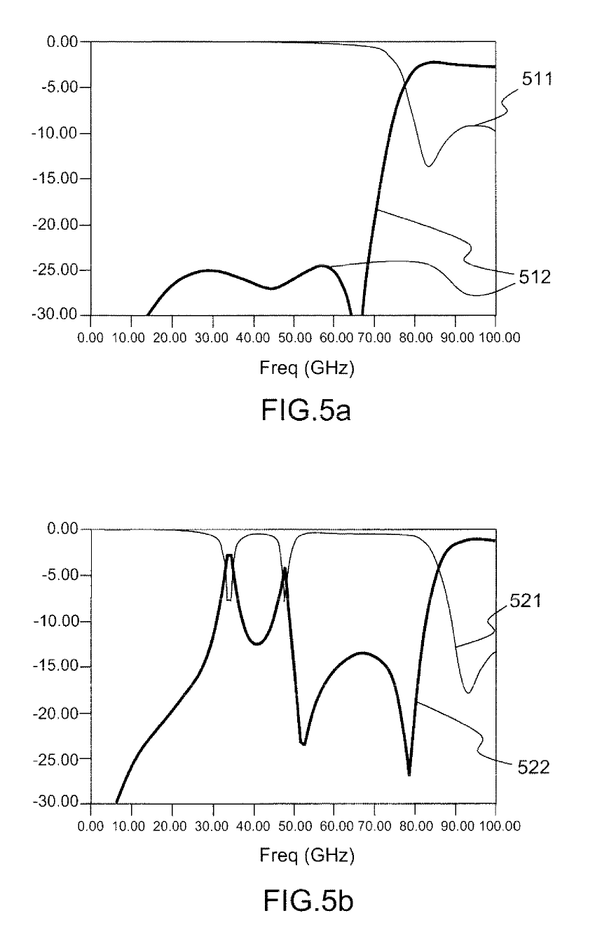

FIGS. 5a and 5b, examples of curves of frequency behaviour of interconnection devices according to two exemplary embodiments of the present invention.

FIG. 1 presents a perspective view of an interconnection device according to an exemplary embodiment of the present invention, linking two electronic modules.

An interconnection device 100 comprising a dielectric substrate 101, electrically links a first electronic module 110 to a second electronic module 120. In the example of the figure, the two electronic modules 110, 120 rest on a conducting support 130. The first electronic module 110 comprises a first dielectric substrate 113. The second electronic module 120 comprises a second dielectric substrate 123. The first electronic module 110 is terminated, on the upper surface of the first dielectric substrate 113, by the end of a first transmission line 111 of microstrip type. The second electronic module 120 is terminated, on the upper surface of the second dielectric substrate 123, by the end of a second transmission line 121 of microstrip type.

The interconnection device 100 comprises on its lower face, a conducting transmission line 103, disposed in parallel, and coupled with an earth line 104. The interconnection device 100 comprises on the upper face of the dielectric substrate 101, a plurality of coupling elements 102. The transmission line 103 comprises at its two ends, connection tags 105. The earth line 104 also comprises at its two ends, connection tags 106. In the example of the figure, conducting vias 112 and 122 passing respectively through the first and second dielectric substrates 113, 123, electrically link the conducting support 130 to two connection pads, not represented in the figure, themselves linked to the connection tags 106 situated at the ends of the earth line 104 of the interconnection device 100. The structures of the two electronic modules 110, 120 are described in detail hereinafter with reference to FIG. 2. The interconnection device 100 is described hereinafter according to various exemplary embodiments of the invention, with reference to FIGS. 3 and 4.

It should be observed that the example illustrated by FIG. 1 exhibits connection tags 105, 106 produced at the ends of the transmission line 103 and of the earth line 104. It is also possible to form connection pads at the ends of the transmission and earth lines 103, 104, for example through a widening of the metallization surface; it is also possible to produce the interconnection directly, substantially at the level of the ends of the transmission and earth lines 103, 104, without tags or pads having to be formed for this purpose. It is also possible to combine these various embodiments, so as to best match the interconnection device to the application for which it is intended.

The example of the figure exhibits electronic modules 110, 120. It should be observed that the term electronic module must be understood in its widest acceptation. It is possible to substitute the electronic modules 110, 120 with electronic chips, three-dimensional modules, hardware components of MEMS type, or else opto-electro-mechanical micro-systems, usually designated by the acronym MOEMS standing for “Micro Opto-Electro-Mechanical System”. In the same manner, the electronic modules 110, 120 comprise in the example of the figure transmission lines of microstrip type, but they can also comprise any other known type of electrical link of wire type, or else of transmission line type.

FIG. 2 presents a perspective view illustrating the detail of the two electronic modules linked electrically by an interconnection device according to an exemplary embodiment of the invention.

The first transmission line 111, made on the upper surface of the first dielectric substrate 113 of the first electronic module 110, is terminated in a connection pad 211 of the transmission line. The first conducting via 112 links the conducting support 130 electrically to a connection pad 212 of the earth.

In the same manner, the second transmission line 121, made on the upper surface of the second dielectric substrate 123 of the second electronic module 120, is terminated in a connection pad 221 of the transmission line. The second conducting via 122 links the conducting support 130 electrically to a connection pad 222 of the earth.

For example, the first substrate 113 of the first electronic module 110 can be made of ceramic, and the second substrate 123 of the second electronic module 120 can be made of a material based on hydrocarbon resin. The dielectric constants of these materials being different, it is thus possible that the thicknesses of the substrates 113 and 123 may be different. An interconnection device according to one of the embodiments of the invention nonetheless allows linkage between elements whose heights are different, through an appropriate choice of the shape of the connection tags or of the mode of fixing them to the connection pads 211, 212, 221, 222. It is indeed possible to use different modes of fixing for fixing the connection tags of the interconnection device to the first electronic module 110 and the second electronic module 120: for example to use micro-balls for fixing the least thick module, and an adhesive bonding-based mode of fixing for the thickest module.

FIGS. 3a and 3b present perspective views illustrating the detail respectively of the underside and of the topside of an interconnection device according to an exemplary embodiment of the present invention.

In this exemplary embodiment illustrated by FIGS. 3a and 3b, initially with reference to FIG. 3a, the interconnection device 100 comprises on the lower face of the substrate 101, the transmission line 103 and the earth line 104, formed in the same plane by metallization surfaces. In the example of the figure, the two lines 103, 104 are disposed in parallel and have the same dimensions. They are both terminated on either side by the connection tags 105, 106, which can be formed by simple metallization surfaces, or else for example by metallizations of greater thickness, or else by fixing micro-balls to metallization surfaces. It is also possible that the connections with electronic circuits may be produced directly by a contact with the ends of the lines 103, 104, without connection tags really being present. The typical dimensions of the interconnection device can be a length of the order of a millimetre, and a thickness of the order of a few tens of micrometers depending on the nature of the dielectric substrate 101, for the transmission of signals that may attain a frequency of the order of 150 GHz. It is not possible to produce effective links using wires or microstrips, allowing the transmission of signals whose frequency is so high, over as great a length.

The material used for the dielectric substrate 101 can for example be a flexible material, such as a resin of polytetrafluoroethylene type, usually designated by the initials PTFE filled with ceramic on woven glass fibre, or else an epoxy resin on woven glass, or any other organic flexible material. The flexibility of the dielectric substrate 101 allows better tolerance of thermomechanical stresses, induced notably by the differences in expansion properties of the various metallic elements. It also allows better tolerance of vibratory stresses induced by the environment in which the interconnection device 100 is situated.

With reference to FIG. 3b, the interconnection device 100 comprises, on the upper face of the dielectric substrate 101, a plurality of coupling elements 102, formed by metallizations, covering a surface of area substantially equal to that of the surface of the lines 103, 104 situated on the other face of the dielectric substrate 101. The coupling elements 102 allow better coupling of the transmission line 103 with the earth line 104. The electromagnetic coupling is thus enhanced, while permitting a relative distancing of the two lines. It is conceivable to form a single coupling element through one and the same metallization surface; however it is advantageous to resort to a plurality of coupling elements 102: this makes it possible not to generate undesirable resonances in the useful band of frequencies. The coupling elements 102 are for example disposed at a determined distance from one another, and in a periodic manner. It is advantageous, for better performance, that the distance separating the coupling elements 102 be as small as possible, with regard to the manufacturing technique used.

The two coupled parallel lines 103, 104, are made so as to offer a standard characteristic impedance, for example a typical impedance for microwave frequencies of 50Ωor 75Ω. It is conceivable not to resort to coupling elements 102; however, if for example inexpensive manufacturing methods are employed, such as chemical etching methods, then the achievable minimum gap between the transmission line 103 and the earth line 104 is too big to ensure satisfactory coupling. The coupling elements 102 thus make it possible to enhance the electrical coupling; furthermore the coupling elements 102 make it possible to adjust the characteristic impedance of the fundamental mode, or so-called quasi-transverse electromagnetic mode or else quasi-TEM mode, that is to say in which the longitudinal component of the electric and magnetic fields is considered to be negligible, propagated over the two coupled parallel lines 103, 104.

FIGS. 4a and 4b present perspective views illustrating the detail respectively of the underside and of the topside of an interconnection device according to an alternative exemplary embodiment of the present invention.

In a manner similar to the embodiment described previously with reference to FIGS. 3a and 3b, initially with reference to FIG. 4a, the interconnection device 100 comprises on the lower face of the substrate 101, the transmission line 103 and the earth line 104, formed in the same plane by metallization surfaces. In this exemplary embodiment, the two lines 103, 104 are not identical. Indeed, the earth line 104 is linked, at the level of its central part, to a double line segment 204, that can also be termed “double stub” according to the terminology usually used in the technical field of the present invention. The double line segment 204 has an influence on the phenomena of spurious resonance, and makes it possible for the high cutoff frequency of the interconnection device 100 to be displaced towards higher frequencies, correspondingly widening its passband. The presence of the double line segment 204 nonetheless introduces low cutoff frequencies. By giving the double line segment 204 a particular shape, it is possible to displace the highest low cutoff frequency towards the low frequencies, and thus to afford the interconnection device 100 a wider band of frequencies, notably in the highest frequencies. For example, the line segment 204 can be linked to the earth line 104 in the middle of the latter, and comprise a surface having the shape of a “T”, whose horizontal branches extend substantially parallel to the earth line 104, over the whole of its length and beyond. The horizontal branches of the “T” formed by the line segment 204 can then, at the level of their distal ends, be prolonged by a surface extending perpendicularly to them. The frequency behaviour of the structures described above with reference to FIGS. 3a, 3b, 4a and 4b, is described in ampler details hereinafter with reference to FIGS. 5a and 5b.

In a similar manner to the previous embodiment, with reference to FIG. 4b, the interconnection device 100 comprises, on the upper face of the dielectric substrate 101, a plurality of coupling elements 102, formed by metallizations, covering a surface of area substantially equal to that of the surface of the lines 103, 104 situated on the other face of the dielectric substrate 101.

It should be observed that the electrical links produced by an interconnection device according to any one of the embodiments of the present invention described above, is a link of mono-mode type, unlike electrical links produced by 3 coplanar lines of earth/signal/earth type. Consequently the electrical link produced by an interconnection device according to any one of the embodiments of the invention is very insensitive to asymmetries. Nonetheless, it is advantageously possible to envisage an alternative embodiment of the invention, applying to the transmission of differential signals, by producing, rather than a transmission line 103 and an earth line 104, three lines: a transmission line for transmitting a first signal, a central earth line, and a second transmission line for transmitting a second signal.

It should also be noted that an electrical link of coplanar type with two lines, such as is presented in the embodiments of the invention described above, exhibits numerous advantages with respect to a known coplanar electrical link of earth/signal/earth type. Notably:
an electrical link of coplanar type with two lines is simpler to implement since it requires a minimum of four attachment points instead of six;
an electrical link of coplanar type with two lines is less bulky, since the two wide earth lines usually present in a known coplanar electrical link of earth/signal/earth type are substituted by a single earth line of lesser width;
an electrical link of coplanar type with two lines exhibits a lesser sensitivity to asymmetries of manufacture and mounting which cause impairments to the link. On coplanar lines with three conductors, such impairments result from the couplings of the even and odd propagation modes;
the use of an electrical link of coplanar type with two lines reduces the production precision required at the level of the gaps separating the coupled lines, notably by virtue of the presence of the coupling elements 102, which allow an enhancement of the coupling between the lines 103, 104, and also make it possible to obtain a characteristic impedance, for example of 50Ω, with wider line gaps. With a known coplanar electrical link of earth/signal/earth type, such advantages can only be obtained at the price of an electrical link from the earth lines up to an earth plane, by using through-vias which are expensive to produce industrially.

The coupling elements 102 present in the exemplary embodiments of the invention described above, form a floating structure. It is, however, possible to envisage electrically linking the coupling elements 102 to the earth line 104 by employing through-vias, with the aim of enhancing the coupling and frequency response performance of the interconnection device.

Advantageously, it is possible to produce several electrical links according to any one of the above-described embodiments of the invention, on one and the same substrate. Such an embodiment can for example be envisaged for effecting with a single device, the electrical link between a plurality of modules. The production of such a device can for example be done according to the TAB technique.

Of course, the interconnection devices according to the above-described embodiments of the invention can also apply to interfaces of slot line type or earth/signal/earth coplanar lines, even though the examples presented apply to interfaces of strip-based link type.

The interconnection devices according to the above-described embodiments of the invention are compatible with industrial means of automatic placement and fixing of hardware components used in microelectronics. Equipment for automatic placement is generally capable of guaranteeing the precision required for the relative positioning of interconnection devices in relation to electronic circuits which have to be electrically linked. Moreover, the positioning constraints can advantageously be relaxed by using a set of interconnection devices 100 of different lengths, this set covering the range of variation of the distances to be covered.

Their fixing to two electronic circuits to be linked can be done by way of means that are in themselves known, for example by spots of conducting adhesive, or via metallic micro-balls, or by soldering, or by thermo-sonics, thermo-compression, or else by a combination of these methods.

FIGS. 5a and 5b present examples of curves of frequency behaviour of interconnection devices according to two exemplary embodiments of the present invention.

FIG. 5a presents more precisely the frequency behaviour of an interconnection device such as described with reference to FIGS. 3a and 3b. An orthonormal reference frame represents as ordinate the attenuation in dB, as a function of the signal frequency plotted as abscissa. A first curve 511 represents the attenuation of signals transmitted through the electrical link formed by the interconnection device. Curve 512 represents the attenuation of signals reflected by the electrical link formed by the interconnection device.

In a similar manner, FIG. 5b presents more precisely the frequency behaviour of an interconnection device 100 such as described with reference to FIGS. 4a and 4b. A first curve 521 represents the attenuation of signals transmitted through the electrical link formed by the interconnection device. Curve 522 represents the attenuation of signals reflected by the electrical link formed by the interconnection device.

With reference to FIG. 5a, the interconnection device 100 such as illustrated by FIGS. 3a and 3b allows an electrical link covering a broad frequency band, typically from 0 to 70 GHz: the two performance curves 511, 512 arise in the example of the figure from a link whose length—that is to say the distance separating the two ends of the connection tags 105, 106, is 800 ∥m.

With reference to FIG. 5b, the interconnection device 100 such as described with reference to FIGS. 4a and 4b allows an electrical link covering a frequency band typically of the order of an octave, for frequencies below 100 GHz. Likewise, the two performance curves 521, 522 arise in the example of the figure from a link whose length—that is to say the distance separating the two ends of the connection tags 105, 106, is 800 μm.

Of course, the values appearing in FIGS. 5a and 5b are given by way of indicative example, and are not restrictive since it is possible to obtain an infinity of solutions by varying the dimensions and the properties of the materials used in the interconnection device.

An interconnection device according to any one of the embodiments described above can also be used to produce a transition between simple coplanar lines of earth/signal/earth type. It can also be used to produce transitions between multiple alternating earth/signal/earth/signal/earth lines, etc. It can also be used to produce multiple transitions around a microwave monolithic integrated circuit which are produced on one and the same flexible structure, that is to say on one and the same substrate. It can also be used to produce a new type of package for monolithic microwave integrated circuits usually designated by the initials MMIC, this new type of package competing with packages employing known techniques such as the aforementioned BGA or LGA, and comprising transitions such as mentioned above, integrated directly on the periphery of the package.

The present invention is particularly appropriate when it is necessary for example to link the inputs and outputs of a low noise amplifier cooled with the aid of thermo-electric micro-systems or other cryogenics systems, these systems imposing lengths of electrical links that are relatively big with regard to the frequencies of the signals involved.

The present invention is also particularly appropriate for the production of power amplifiers in general, since the assemblies which ensure the dissipation of the power complicate the production of short links towards the microwave inputs-outputs. If particular care is taken to ensure a low electrical resistivity and a large cross section on the conductors, then the interconnection devices according to the various embodiments of the invention are particularly well suited for supporting electrical signals of high power.

The present invention is also particularly appropriate for the production of wide frequency band power amplifiers, often embodied using monolithic technology based on Gallium Arsenide (AsGa), Gallium Nitride (GaN), or Silicon-Germanium (SiGe).

The present invention is also particularly appropriate for the production of very wide frequency band medium power amplifiers, typically distributed amplifiers, using InP (Indium Phosphide) technology, which are used in ultra high throughput links (40 Gb/s and above) on optical fibres.

The present invention is also very appropriate for the production of MMIC circuits (AsGa and SiGe) forming phase and amplitude control chips in active antenna modules for radars and especially for radar devices demanding the processing of very wide band signals.

The present invention is also very appropriate for the production of ultra-wide band receivers and transmitters.

The present invention is also particularly appropriate for the production of microelectronic devices requiring thermal conditioning at very low temperature.

The present invention is also particularly appropriate for the production of power amplifiers of high efficiency (typically in classes C,E,D,F and Inverse Class-F, etc.), since although not generally being wide band, they make it necessary to curb the impedances exhibited at the first two harmonics.

The present invention is also particularly appropriate for the production of microelectronic components such as MEMS or MOEMS, on which the distances between the connection tags and the cut edges of the substrate are usually very large.

It should be noted that the applications mainly targeted by the present invention typically involve signal frequencies situated above 30 GHz (K band) and/or entailing large power, that is to say above 3 W. It is possible, however, to find a similar interest for such interconnection devices, in applications involving signals of lower frequency (for example in the S band), of very high power and requiring a very low manufacturing cost, and starting from substrates with very broad cutting rules. Applications of this type are typically encountered in the case of power amplifiers produced using GaN technology. Indeed, this technology makes it possible to reach very high power densities (in W/mm² of substrate) with higher characteristic impedances than for AsGa technology. GaN technology therefore promotes the emergence of new monolithic power amplifiers with ever higher power densities, which are matched for standard impedance levels (typically 50Ω), and which require effective solutions for power dissipation. In these cases, the interconnection devices according to the various embodiments presented of the invention, turn out to be very effective in releasing the constraints of dimensions of the cooling system at the chip level.

Of course, the structure of an interconnection device according to any one of the embodiments presented of the invention, can be optimized as a function of the applications aimed at. Such is for example the case for applications requiring outputs on low characteristic impedances, for semiconductor components of very high power. Such applications make it necessary for example to use vias so as to superimpose the lines and generate a characteristic impedance of low value. It is also possible to add a function of impedance matching to the electrical link, by adding additional elements such as capacitors to the transmission line.

An interconnection device according to any one of the embodiments of the invention can also be optimized so as to adjust the passband offered, so as to afford it an additional filtering function. For more elaborate filtering applications, it can also be supplemented with specific resonators.

1- An interconnection device for electronic circuits, comprising at least one transmission line coupled to an earth line, the two said earth and transmission lines being made on a face of a dielectric substrate, at least one metallization surface forming on the other face of the dielectric substrate at least one coupling element for enhancing the electrical coupling between the earth and transmission lines, the said coupling element being disposed on a surface substantially equal in area to the surface occupied by the transmission line and the earth line, the interconnection being carried out substantially at the ends of the transmission line and of the earth line.

2- An interconnection device according to claim 1, wherein the transmission line and the earth line are terminated at their ends by connection pads.

3- An interconnection device according to claim 1, wherein the transmission line and the earth line are terminated at their ends by connection tags.

4- An interconnection device according to claim 1, wherein a plurality of coupling elements is formed by a plurality of metallization surfaces of identical shapes disposed in a substantially periodic manner at a determined distance from one another.

5- An interconnection device according to claim 1, wherein the transmission line and the earth line are substantially of the same dimensions and disposed in parallel.

6- An interconnection device according to claim 1, wherein the earth line is linked at the level of its central part, to a double line segment increasing the high cutoff frequency of the interconnection device.

7- An interconnection device according to claim 6, wherein the double line segment exhibits substantially a “T” shape whose vertical branch is linked at the level of the central part of the earth line, the horizontal branches extending parallel to the earth line over a length at least equal to the length of the earth line, the distal ends of the horizontal branches being prolonged by a surface extending perpendicularly to them.

8- An interconnection device according to claim 1, wherein a first transmission line is disposed parallel to the earth line disposed parallel to a second transmission line, the three lines forming a system of signal/earth/signal type.

9- An interconnection device according to claim 1, wherein the coupling elements are linked electrically to the earth line by conducting vias passing through the dielectric substrate.

10- An interconnection device according to claim 1, wherein a plurality of electrical links each formed by at least one transmission line and one earth line are made on the dielectric substrate.

11- An interconnection device according to claim 1, wherein the dielectric substrate is made of a flexible material.

12- An interconnection device according to claim 10, wherein the flexible material is a resin of polytetrafluoroethylene type filled with ceramic on woven glass fibre, or else an epoxy resin on woven glass, or any other organic flexible material.

13- An interconnection device according to claim 1, wherein the lines are made by a TAB-type tape-based automatic adhesive bonding technique.
